(19) United States
(12) Patent Application Publication
(10) Pub. No.: US 2015/0379168 A1
(43) Pub. Date: Dec. 31, 2015

(54) TECHNIQUES FOR SIMULATING KINESTHETIC INTERACTIONS

(71) Applicant: Amazon Technologies, Inc., Reno, NV (US)

(72) Inventors: Janet Ellen Galore, Seattle, WA (US); Gonzalo Alberto Ramos, Kirkland, WA (US); Snehal S. Mantri, Seattle, WA (US); Jenny Ann Blackburn, Seattle, WA (US)

(21) Appl. No.: 14/318,032

(22) Filed: Jun. 27, 2014

(51) Int. Cl. G06F 17/50; G06Q 30/06

(52) U.S. Cl. CPC G06F 17/5009; G06Q 30/0601

(57) ABSTRACT

Sensor data is received from an electronic device, the sensor data corresponding to a kinesthetic interaction by a user with respect to an electronic presentation of an item offered in an electronic marketplace. A material simulation model associated with the item is obtained, as is metadata related to the item. Sensory output is identified utilizing the sensor data, the metadata, and the material simulation model, the sensory output simulating a corresponding physical interaction by the user with the item. The sensory output may be provided for presentation on the electronic device.

### BACKGROUND

Merchants, vendors, sellers and others may offer items (e.g., goods and/or services) for consumption via an electronic marketplace. Users may utilize an electronic device (e.g., a smartphone) to traverse the electronic marketplace in search of such items. Current techniques for presenting an item offered via an electronic marketplace are limited. For example, a user may view an image of an item he or she wishes to purchase via the electronic marketplace, and may view textual information regarding the item, but little else. This limitation makes it difficult for the user to determine various attributes, including tactile attributes, of the item he or she is seeking to purchase. Often times, the user must wait until the item is delivered before he or she may fully appreciate various aspects of the item.

### BRIEF DESCRIPTION OF THE DRAWINGS

Various embodiments in accordance with the present disclosure will be described with reference to the drawings, in which:

FIG. 1 is a pictorial diagram illustrating an example environment for implementing features of a simulation engine in accordance with at least one embodiment;

FIG. 2 is a pictorial diagram illustrating an example of capturing kinesthetic information used by the simulation engine to simulate a user's interaction with an item of interest available from an electronic marketplace, in accordance with at least one embodiment;

FIG. 3 is a pictorial diagram illustrating an example of receiving of sensor data used by the simulation engine to simulate a user's interaction with an item of interest, in accordance with at least one embodiment;

FIG. 4 is a pictorial diagraming illustrating another example of receiving sensor data used by the simulation engine to simulate a user's interaction with an item of interest, in accordance with at least one embodiment;

FIG. 5 is a pictorial diagram illustrating a further example of receiving sensor data used by the simulation engine to simulate a user's interaction with an item of interest, in accordance with at least one embodiment;

FIG. 6 is a pictorial diagram illustrating yet a further example of receiving sensor data used by the simulation engine to simulate a user's interaction with an item of interest, in accordance with at least one embodiment;

FIG. 7 is a block diagram illustrating an example computer architecture for enabling a user to procure items from the electronic marketplace utilizing the simulation engine, in accordance with at least one embodiment;

FIG. 8 is a block diagram illustrating an example computer architecture for implementing the simulation engine, in accordance with at least one embodiment;

FIG. 9 is a flowchart illustrating an example method for generating a simulated interaction between a user and an item of interest based on kinesthetic information utilizing a simulation engine, in accordance with at least one embodiment; and

FIG. 10 is a flowchart illustrating another example method for generating a simulated interaction between a user and an item based on kinesthetic information utilizing a simulation engine, in accordance with at least one embodiment.

### DETAILED DESCRIPTION

Techniques described herein are directed to systems and methods for simulating a physical interaction between a user and an item based on a kinesthetic interaction between the user and an electronic representation of the item. In some embodiments, the item of interest is available for purchase from an electronic marketplace, and the generated simulated interaction is utilized the user to assist in making a purchase decision for the item. As used herein, the term “kinesthetic” includes, but is not limited to, any suitable force, movement, or sound initiated from and/or by a person and/or device (e.g., a capture device). Though “purchasing” is used in examples contained herein, the present disclosure may apply to any method by which a user may obtain an item. In addition, although simulation of a user's interaction with a “fabric” attribute of an item is often used as an example herein, the present disclosure may apply to any sensory attribute of an item. As described herein, an electronic marketplace may generally refer to a virtual market through which users may buy and sell items using an electronic catalog of items. As used herein, a “kinesthetic interaction” is intended to refer to a movement or force initiated by a user with respect to an electronic representation of an item presented on an electronic device, where the movement or force is being received by the electronic device. A movement or force includes, but is not limited to, a user blowing air into a microphone, the user holding (or otherwise touching) the device, the user moving the device, and the user's eye movement. As used herein, a “physical interaction” with an item results from a physical action taken with respect to a physical item, whereas a “kinesthetic interaction” results from a kinesthetic action taken with respect to an electronic representation of the item presented on an electronic device. “Sensory feedback” or “sensory output” as used herein, is intended to refer to output related to at least one of a sensory attribute such as sight, sound, taste, smell, and touch. As used herein, an “electronic representation” is intended to mean an image, a video, and/or audio, or other suitable depiction of an item, the depiction occurring on an electronic device. In the following examples, the simulation engine may reside, either wholly or partially, on any electronic device depicted. Additionally, or alternatively, the simulation engine may reside, either wholly or partially, on a system remote to the electronic device. Although sensory output described below is often described as being presented by one electronic device, it should be appreciated that any sensory output described below may be presented on one or more electronic devices, simultaneously or otherwise.

As part of a system or method for simulating physical interactions between a user and an item of interest available from an electronic marketplace, a simulation engine may be provided. In at least one embodiment, the simulation engine may be internal or external with respect to the electronic marketplace.

In at least one example, a merchant, vendor, seller or other user (generally referred to herein as a “seller”) of an electronic marketplace may offer an item for sale via the electronic marketplace. A user may navigate to a network page providing a description (e.g., image(s), descriptive text, price, weight, size options, reviews, etc.,) for the item (an “item detail page”) utilizing, for example, a browsing application. In at least one example, the user may select an option to kinesthetically interact with the electronic representation of the item (e.g., a button, a hyperlink, a checkbox, etc.). The user may then kinesthetically interact with an electronic representation of the item (e.g., an image for the item) using his or her electronic device (e.g., a smartphone). Such a kinesthetic interaction with the electronic device will produce sensor data that may be mapped to a previously captured, kinesthetic information that may be presented as sensory output simulating a corresponding physical interaction with the physical item. Alternatively, if kinesthetic information has not been previously captured, the simulation engine may generate and/or interpolate sensory output for the item for presentation to the user. The sensory output may simulate a visual, audible, haptic/tactile, or other suitable physical interaction with the item based on the kinesthetic interaction between the user and the electronic representation of the item. The user may experience such output utilizing the electronic device.

In accordance with at least one embodiment, various reactions of an item to kinesthetic stimuli (such reactions may be referred to herein as “kinesthetic reactions” or “kinesthetic information”) may be captured or otherwise obtained. For example, a video of an item of clothing, such as a dress, may be captured as the item is being waved back and forth or bounced on a hanger. Video may also be captured of the item responding to one or more wind sources. Additionally, audio may be captured of the item when rubbed, tapped, or subjected to another kinesthetic stimulus. Accordingly, when a user navigates to an item detail page for the item (or some other network page related to the item) on the electronic marketplace, the user may kinesthetically interact with the electronic representation of the item. For example, a user may navigate to an item detail page for a dress using a smartphone, and while viewing an image for the dress on the item detail page, the user may wave the smartphone back and forth to simulate waving the dress on a clothes hanger. Such a kinesthetic interaction may be detected by various sensors (e.g., an accelerometer, a microphone, a haptic recorder, a digital camera (or other image capturing device), etc.) on the user's electronic device. The simulation engine may then use the sensor data produced by the sensors, as well as metadata associated with the item (e.g., a weight, a fabric type, an opaqueness, etc.), to identify one or more of the previously captured videos, audio or other kinesthetic information to present to the user as sensory output. The sensory output may then be output by the electronic device to simulate a physical interaction with the item (e.g., waving the dress on the hanger) based on the user's kinesthetic interaction with the electronic representation of the item using the electronic device (e.g., the user waving the smartphone back and forth while viewing the image for the dress).

Depending on the capabilities of the electronic device, if previously captured kinesthetic information is not available that corresponds to the received sensor data, the simulation engine may generate and/or interpolate a sensory output for the item for presentation to the user. Generation of the sensory output may utilize the sensor data, the metadata, and/or a material simulation model that simulates one or more materials from which the item is made or that are included in the item. Interpolating the sensory output may utilize at least one of the sensor data, the metadata, a material simulation model, and previously captured kinesthetic information. The simulated and/or interpolated sensory output may be provided for presentation on one or more electronic devices.

As yet another example, a first video may be captured for an item while the item is moved back and forth at speed A. A second video may be captured for the item while the item is being moved back and forth at speed B. Subsequently, a user browsing an item detail page for the item using an electronic device, may simulate physically moving the item back and forth by moving the electronic device presenting an electronic representation of the item back and forth at speed C. Upon receipt of sensor data produced by one or more sensors, e.g., an accelerometer, on the user's electronic device while the user is moving the electronic device back and forth at speed C, the simulation engine may generate and/or interpolate sensory output for the item. In other words, though captured kinesthetic information does not exist that simulates the item being moved back and forth at speed C, previously captured kinesthetic information may be interpolated to generate sensory output simulating the item being moved back and forth at speed C. The sensory output may be interpolated from information about the item (e.g., the item's weight, fabric type, etc.) and the previously captured kinesthetic information, e.g., data from the first and second videos depicting the item moving at speed A and at speed B, respectively. If captured kinesthetic information does not exist at all for the item being moved, or the captured kinesthetic information is unsuitable for interpolation, the simulation engine may generate an entirely new sensory output utilizing, for example, information about the item and a material simulation model.

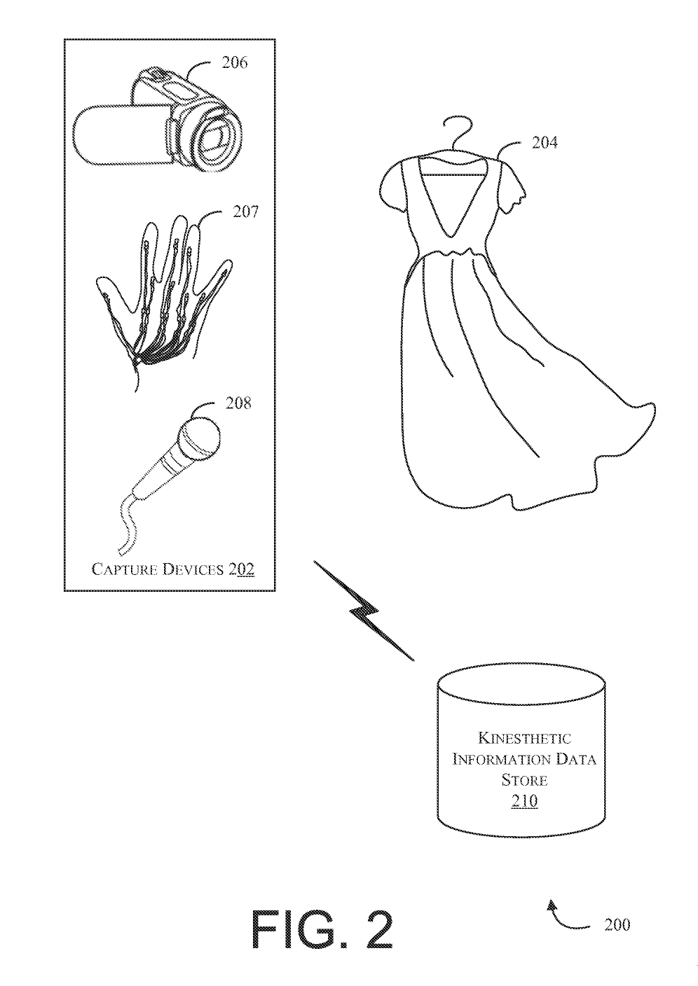

Although illustrations utilizing videos were discussed above, it should be appreciated that any suitable kinesthetic information may be captured and utilized to generate sensory output as will be discussed further in FIGS. 2-6.

Thus, in accordance with embodiments, systems and methods are provided for enabling a user to experience generated/interpolated sensory output that simulate a physical interaction with an item based on a kinesthetic interaction with an electronic representation of the item.

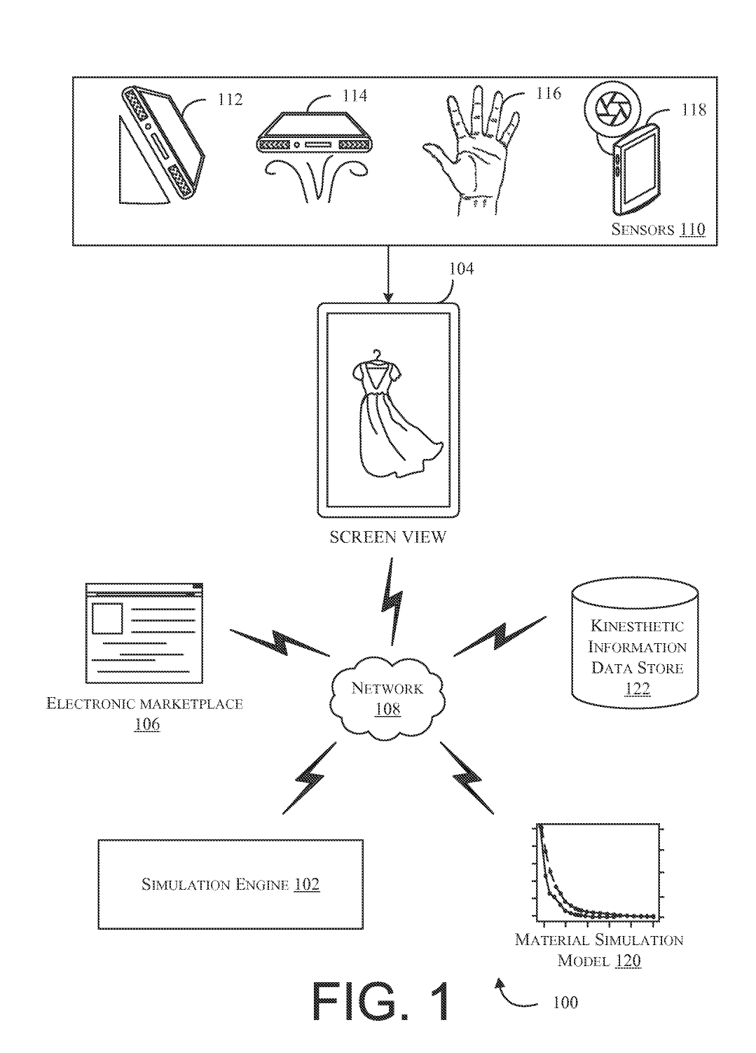

Referring now to the drawings, in which like reference numerals represent like parts, FIG. 1 illustrates an example environment 100 for implementing the features of a simulation engine 102. A user may utilize an electronic device 104 to search for items to procure from an electronic marketplace. Illustratively, the electronic device may be a personal computing device, hand held computing device, terminal computing device, mobile device (e.g., mobile phones or tablet computing devices), wearable device configured with network access and program execution capabilities (e.g., “smart eyewear” or “smart watches”), wireless device, electronic reader, media player, home entertainment system, gaming console, set-top box, television configured with network access and program execution capabilities (e.g., “smart TVs”), or some other electronic device or appliance.

In some examples, the electronic device 104 may be in communication with an electronic marketplace 106 via a network 108. For example, the network 108 may be a publicly accessible network of linked networks, possibly operated by various distinct parties, such as the

Internet. The network 108 may include one or more wired or wireless networks. Wireless networks may include a Global System for Mobile Communications (GSM) network, a Code Division Multiple Access (CDMA) network, a Long Term Evolution (LTE) network, or some other type of wireless network. Protocols and components for communicating via the Internet or any of the other aforementioned types of communication networks are well known to those skilled in the art of computer communications and thus, need not be described in more detail herein.

In accordance with at least one embodiment, a user may utilize electronic device 104 to access the electronic marketplace 106 to select an item he wishes to procure. The user, in one example, may navigate to a network page referring to the item (e.g., an item detail page) provided by the electronic marketplace 106 and select an option to kinesthetically interact with the item. Upon selection, the user may kinesthetically interact with the electronic device 104 as described above. Such a kinesthetic interaction may be detected by various sensors (e.g., an accelerometer, a microphone, a haptic recorder, a digital camera, etc.) on the user's electronic device. The simulation engine may then use the sensor data produced by the sensors. For example, sensors 110, located on electronic device 104, may provide sensor data 112, 114, 116, and/or 118. Sensor data 112 may be generated based on tilt angles of the electronic device (e.g., via accelerometer readings). Sensor data 114 may be generated based on information received from, for example, a microphone. Sensor data 116 may be generated via a resistive system, a capacitive system, a surface acoustic wave system, or any haptic system and/or sensor configured to recognize touch. Sensor data 115 may be generated by video capture from a digital camera located on the electronic device.

In accordance with at least one embodiment, simulation engine 102 may receive sensor data from sensors 110. Upon receipt, the simulation engine may determine various metadata related to the item selected by the user. For instance, in an example where the user is viewing a curtain on the electronic marketplace 106, metadata of the curtain may include, but is not limited to, a weight, a type of fabric, a length, a width, a style, and a degree of opaqueness. The simulation engine may then use the sensor data 112, 114, 116, and/or 118 produced by the sensors 100, as well as the determined metadata related to the item to identify previously captured kinesthetic information to present to the user as sensory output via the electronic device 104.

If previously captured kinesthetic information is not available that corresponds to the received sensor data 112, 114, 116, and/or 118 produced by the sensors 100, the simulation engine 102 may determine the capabilities of electronic device 104. If the electronic device is capable, the simulation engine 102 may generate and/or interpolate sensory output for the item rather than rely on previously captured kinesthetic information. Capabilities of an electronic device may include, but are not limited to, a processor speed, an operating system, an available amount of memory, etc. In at least one example, depending on the capabilities of the electronic device 104, simulation engine 102 may utilize a material simulation model 120 to generate and/or interpolate sensory output for the item. Material simulation model 120 may include a mapping of one or more types of sensor data to one or more sensory outputs simulating a physical interaction with a physical item. Alternatively, the material simulation model may include a graphics simulation model and may provide an approximate simulation of certain physical aspects or systems of an item, such as rigid body dynamics, soft body dynamics, fluid dynamics, and material dynamics.

In accordance with at least one embodiment, sensory outputs that simulate a physical interaction with a physical item may be captured and stored in kinesthetic information data store 122. In an illustrative example, these sensory outputs may include video recordings and/or still images of the item in motion and/or audio recordings and/or haptic recordings of the item. Simulation engine 102 may utilize material simulation model 120 to provide sensory output to be presented on electronic device 104. Simulation engine 102 and/or material simulation model 120 may utilize data stored in kinesthetic information data store 122 to provide such sensory output. For example, material simulation model 120 may include a mapping of particular sensor readings (e.g., accelerometer data indicating a waving motion of speed A) to kinesthetic information including a video that depicts the item being waved back and forth at speed A. If a video is not available depicting the item being waved back and forth at speed A, simulation engine 102 may utilize material simulation model 120 to interpolate a sensory output. More specifically, the sensory output may be interpolated from the metadata, information from the kinesthetic information data store 122, and/or the sensor data received from sensors 110 and the sensory output may be provided for presentation on the electronic device 104. However, if no kinesthetic information has been previously captured or stored, the simulation engine 102 may utilize material simulation model 120 to generate, using the metadata and/or the sensor data received from sensors 110, the sensory output to be provided for presentation.

FIG. 2 is a pictorial diagram illustrating an example of a process 200 for capturing kinesthetic information in accordance with at least one embodiment. Capture devices 202 may be used to obtain kinesthetic information related to an item 204. For example, capture devices may be a video recorder/digital camera 206, a haptic recorder 207, an audio recorder 208, or any suitable device capable of capturing video, haptic, and/or audio information of item 204.

In at least one example, video recorder/digital camera 206 may be used to record various videos and/or still images of item 204. For example, item 204 may be recorded blowing in the wind, the wind being generated by, for example, a stationary fan set to a low setting. The video may be stored in kinesthetic information data store 210 (e.g., kinesthetic information data store 122 of FIG. 1). Metadata related to the video may be also be stored in kinesthetic information data store 210. In this example, metadata related to the video may include a speed at which the wind was blowing when the video was taken (e.g., two miles per hour) as well as a direction relative to item 204 (e.g., at a 45 degree angle). In an additional example, the item 204 may be waved back and forth from the hanger at a first speed, a second speed, and a third speed. The second speed may be faster than the first speed, while, similarly, the third speed may be faster than the second speed. These videos may also be stored in kinesthetic information data store 122. As a further example, item 204 may be recorded using video recorder/digital camera 206 with an object (e.g., a hand) behind the item. In such a video, an opaqueness of the item 204 may be apparent. For instance, if the item 204 is made of linen, the opaqueness may be greater than an item 204 made of, for example, silk.

In accordance with at least one embodiment, haptic recorder 207 may be utilized to record kinesthetic information such as haptic inputs. As an illustrative example, haptic recorder 207 may constitute a haptic glove that is capable of recording various inputs corresponding to the sense of touch. The haptic recorder 207 may be utilized to interact with the item, for example, running fingers down the length of an item (e.g., a piece of clothing), rubbing the item between fingers, stretching the item, or any suitable action having a corresponding touch factor. The “feel” of the material (e.g., as detected by the haptic recorder 207) may be recorded and the corresponding data may be stored in kinesthetic information data store 210.

In accordance with at least one embodiment, audio recorder 208 may be utilized to record various sounds of the item 204 when the item 204 is physically interacting with another object. In an illustrative example, a person may rub the fabric between their fingers. The sound made by such a reaction may be captured by audio recorder 208 and the recording may be stored in kinesthetic information data store 210. As those skilled in the art will appreciate, capture devices 202 may include any suitable electronic device capable of capturing and storing kinesthetic information related to a sense of sight, sound, taste, smell, or touch. It should be appreciated that various video, still images, haptic, and/or audio recordings may be captured by capture devices 202 and stored in kinesthetic information data store 210. The type and breadth of such kinesthetic information would be obvious to one skilled in the art of marketing.

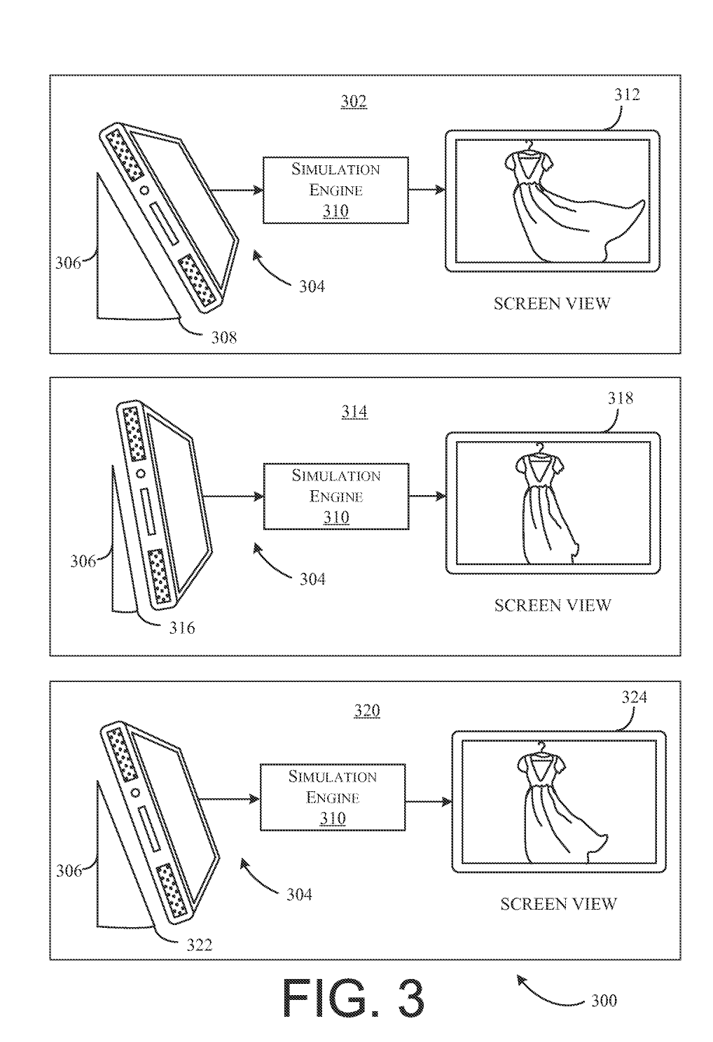

FIG. 3 is a pictorial diagram illustrating an example implementation 300 for receiving sensor data used by the simulation engine to identify, generate or interpolate sensory output in accordance with at least one embodiment. In a use case 302, while electronic device 304 (e.g., the electronic device 104 of FIG. 1) is displaying an electronic representation of an item, an electronic device 304 may be tilted from a substantially vertical position 306, to a first angle 308 (e.g., ˜45 degrees from substantially vertical), and returned to the substantially vertical position 306 within a threshold amount of time. Upon receipt of sensor data detecting/recording such movement of the electronic device 304, simulation engine 310 (e.g., simulation engine 102 of FIG. 1) using metadata related to the item and the sensor data received from the electronic device 304, may determine that previously captured kinesthetic information, e.g., video 312, illustrates the motion described above. Thus, the simulation engine 110 may provide the previously captured video 312 to the electronic device 304 for presentation as sensory output.

A use case 314 illustrates another example in accordance with at least one embodiment. In use case 314, while electronic device 304 is displaying an electronic representation of an item, the electronic device 304 may be tilted from a substantially vertical position 306, to a second angle 316 (e.g., ˜15 degrees from substantially vertical) and returned to the substantially vertical position 306 within a threshold amount of time. The threshold amount of time in this example may be greater or less than the threshold described in use case 302. Upon receipt from the electronic device 304 of sensor data detecting/recording such movement, simulation engine 310, using metadata related to the item and the sensor data received from the electronic device, may determine that previously captured kinesthetic information, e.g., video 318, illustrates the motion described above. The simulation engine 310 may provide the previously captured video 318 to the electronic device 304 for presentation as sensory output. However, in this example, previously captured video 318 may simulate a physical interaction with the item that is less pronounced than that found in previously captured video 312 due to the second angle 316 being less than the first angle 308 in use case 302.

A use case 320 illustrates a further example in accordance with at least one embodiment. In use case 320, electronic device 304 may be tilted from a substantially vertical position 306, to a third angle 322 (e.g., ˜30 degrees from substantially vertical) and returned to the substantially vertical position 306 within a threshold amount of time. The threshold amount of time in this example may be greater or less than the threshold described in use case 302 and use case 314. Upon receipt from the electronic device 104 of sensor data detecting/recording such movement, simulation engine 310, using metadata related to the item and the sensor data received from the electronic device, may determine that no previously captured kinesthetic information corresponds to a motion indicated by such sensor data. Simulation engine 310 may then utilize a material simulation model (e.g., the material simulation model 120 of FIG. 1) to interpolate a movement by the item (e.g., item 204) corresponding to the motion described above. For example, the simulation engine 310 may utilize metadata associated with the item, sensor data indicating the motion described above, and either and/or both captured video 312 and 318 to generate a video 324 to be presented on electronic device 304 as sensory output. Video 324 may depict the item moving 50% less than the item moved in captured video 312 and approximately 50% more than the item moved in video 324.

Alternatively, the simulation engine 310 may generate a video 324 without utilizing previously captured video 312 or captured video 318. In an illustrative example, assume that captured video 312 and captured video 318 do not exist, or are otherwise unavailable. In such a case, simulation engine 310 may utilize metadata associated with the item and sensor data indicating the motion described above to generate the video 324 for presentation on electronic device 304 as sensory output.

With respect to aforementioned examples, previously captured video 312, previously captured video 318, and/or video 324 may be provided to, and/or presented on, the electronic device 304 substantially simultaneously (e.g., in real-time, or near real-time) with respect to the receipt of the corresponding sensor data. Alternatively, previously captured video 312, previously captured video 318, and/or video 324 may be provided to, and/or presented on, the electronic device 304 within a threshold amount of time with respect to the receipt of the sensor data. A delay between the receipt of sensor data and the presentation of sensory output may afford the user time to obtain a desirable viewing angle on the electronic device 304 at which to experience the sensory output.

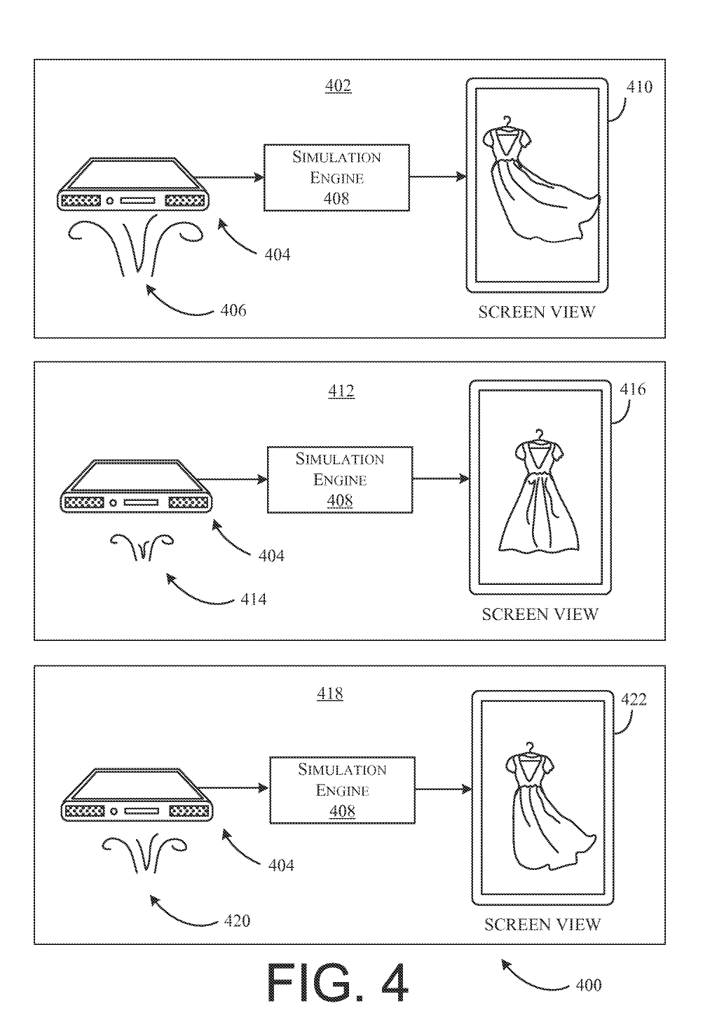

FIG. 4 is a pictorial diagram illustrating an example implementation 400 for receiving sensor data used by the simulation engine to identify, generate or interpolate sensory output in accordance with at least one embodiment. In a use case 402, while electronic device 404 (e.g., the electronic device 104 of FIG. 1) is displaying an image of an item, the electronic device 404 may receive microphone input 406 indicating a person blowing hard into the microphone for a threshold amount of time. Upon receipt from electronic device 404 of sensor data detecting/recording such action, the simulation engine 408 (e.g., simulation engine 102 of FIG. 1), using metadata related to the item and the sensor data received from the electronic device, may determine that previously captured kinesthetic information, e.g., video 410, illustrates the action described above. Thus, the simulation engine 408 may provide the previously captured video 410 to the electronic device 404 for presentation as sensory output.

A use case 412 illustrates another example in accordance with at least one embodiment. In use case 412, while electronic device 304 is display an electronic representation of the item, electronic device 404 may receive microphone input 414 indicating a person blowing softly into the microphone for a threshold amount of time. The threshold amount of time in this example may be greater or less than the threshold described in use case 402. Upon receipt of sensor data detecting/recording such action, simulation engine 408 (e.g. simulation engine 102 of FIG. 1), using metadata related to the item and the sensor data received from the electronic device 404, may determine that previously captured kinesthetic information, e.g., video 416, illustrates the action described above. The simulation engine 408 may provide the previously captured video 416 to the electronic device 404 for presentation as sensory output. However, in this example, previously captured video 416 may simulate a physical interaction with the item that is less pronounced than that found in previously captured video 410 due to the microphone input 414 being softer than the microphone input 406.

A use case 418 illustrates still one further example in accordance with at least one embodiment. In use case 418, electronic device 404 may receive microphone input 420 indicating a person blowing, for a threshold amount of time, some degree between the force necessary to produce microphone input 406 and microphone input 414. The threshold amount of time in this example may be greater or less than the threshold described in use case 402 and use case 412. Upon receipt from the electronic device 404 of sensor data detecting/recording such action, the simulation engine 408, using metadata related to the item and the sensor data received from the electronic device, may determine that no previously captured kinesthetic information corresponds to microphone input 420. In this case, simulation engine 408 may utilize a material simulation model (e.g., the material simulation model 120 of FIG. 1) to generate/interpolate a new sensory output simulating movement by the item (e.g., item 204). For example, simulation engine 408 may utilize metadata associated with the item, microphone input 420, and either and/or both captured video 410 and 416 to generate a video 422 to be presented (e.g., on electronic device 404) as sensory output. In this example, video 422 may depict the item moving some amount less than the item moved in captured video 410 and some amount more than the item moved in captured video 416.

With respect to aforementioned examples, previously captured video 410, previously captured video 416, and/or video 422 may be provided to, and/or presented on, the electronic device 404 substantially simultaneously (e.g., in real-time, or near real-time) with respect to the receipt of the corresponding sensor data. Alternatively, previously captured video 410, previously captured video 416, and/or video 422 may be provided to, and/or presented on, the electronic device 104 for presentation within a threshold amount of time with respect to the receipt of the sensor data. A delay between the input of sensor data and the presentation of video 422 may afford the user time to obtain a desirable viewing angle on the electronic device 304 at which experience the sensory output.

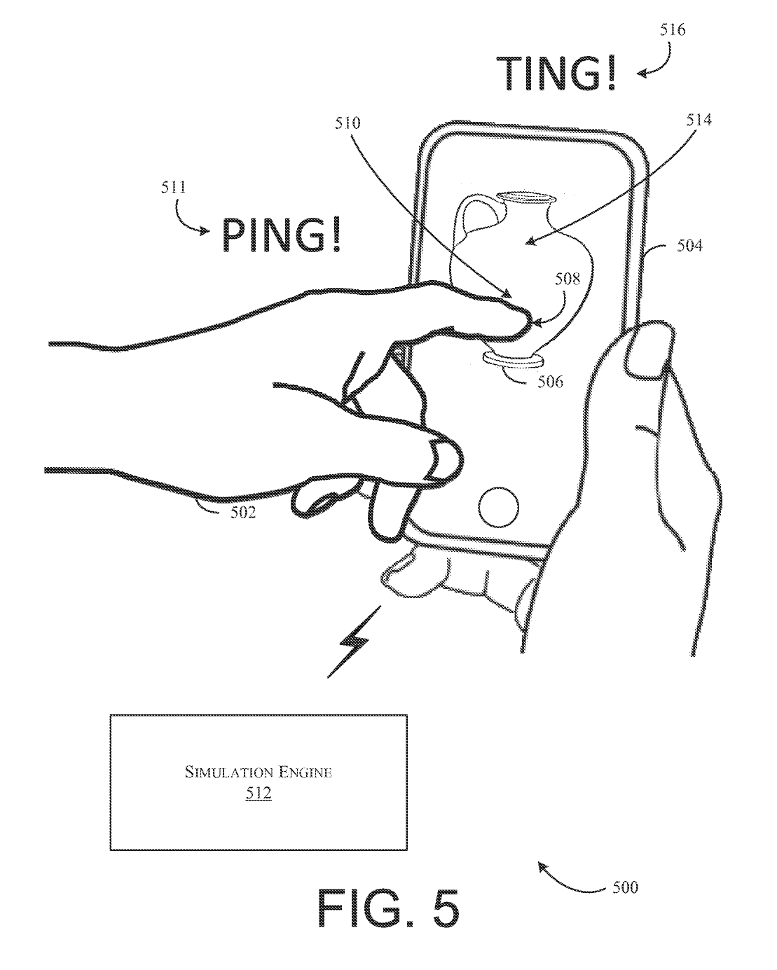

FIG. 5 is a pictorial diagram illustrating a further example implementation 500 for receiving sensor data used by the simulation engine to identify, generate, or interpolate sensory output in accordance with at least one embodiment. In the illustrated example implementation, a user 502 utilizes electronic device 504 (e.g., the electronic device 104 of FIG. 1) to browse to an item 506 (e.g., the item 204 of FIG. 1) offered in an electronic marketplace (e.g., the electronic marketplace 106 of FIG. 1). In this example, item 506 is a vase. The user 502 may indicate via electronic device 504 a desire to “hear” what item 506 sounds like. For example, user 502 may “tap,” using finger 508 on area 510 of item 506, thus, generating sensor data. Simulation engine 512 (e.g., simulation engine 102 of FIG. 1), upon receipt of such sensor data, may determine that previously captured kinesthetic information, e.g., an audio recording 511, corresponds to the tapping the vase corresponding to area 510. Simulation engine 512 may then cause the audio recording 511 to be output as sensory output via electronic device 504.

In accordance with at least one embodiment, the user 502 may “tap” on area 514 of item 506, thus, generating sensor data. Simulation engine 512, upon receipt of such sensor data, may determine that previously captured kinesthetic information, e.g., another audio recording 516, corresponds to tapping the vase corresponding to area 514. Simulation engine 512 may then cause the audio recording 516 to be output as sensory output via electronic device 504. Alternatively, simulation engine 512 may determine that no previously captured kinesthetic information exists that corresponds to a tap by the user at area 514. In this case, simulation engine 512 may generate/interpolate a new sensory output, e.g., an audio recording 516 simulating tapping of the vase using audio recording 511 and metadata (e.g., dimensions, type of material, etc.) associated with item 506.

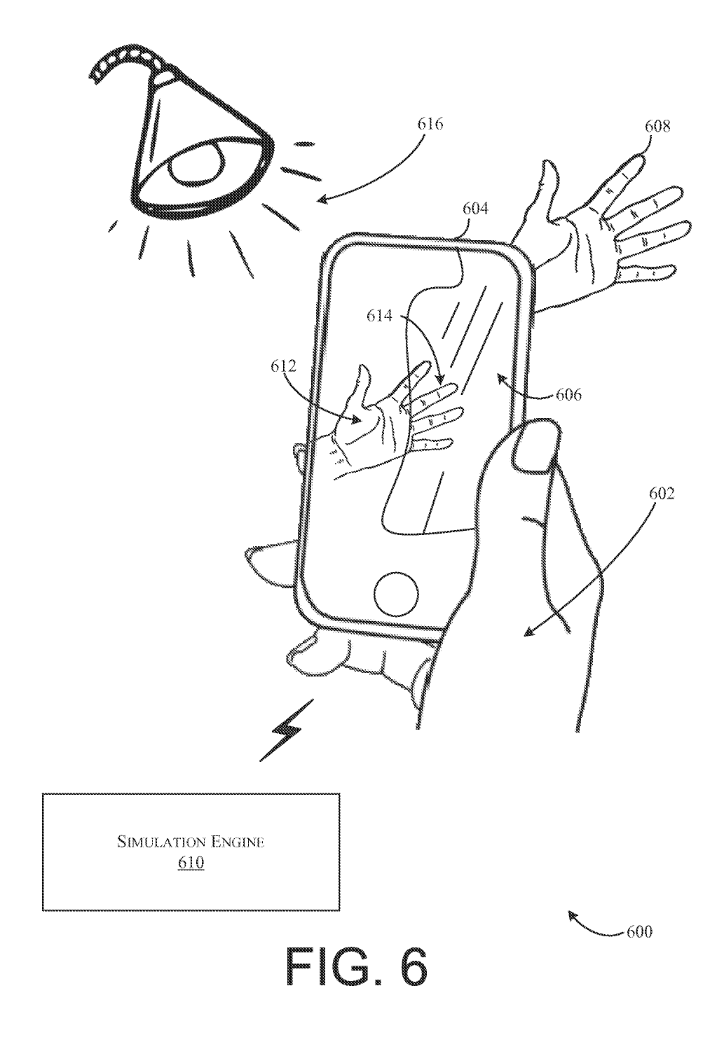

FIG. 6 is a pictorial diagram illustrating yet a further example implementation 600 for receiving sensor data used by the simulation engine to identify, generate or interpolate sensory output in accordance with at least one embodiment. In the illustrated example implementation, a user 602 utilizes electronic device 604 (e.g., the electronic device 104 of FIG. 1) to browse to an item 606 (e.g., the item 204 of FIG. 1) offered in an electronic marketplace (e.g., the electronic marketplace 106 of FIG. 1). In this example, item 606 is a silk curtain. The user 602 may utilize a camera on electronic device 604 to record an image (e.g., a photo or a video) of the user's hand 608.

In accordance with at least one embodiment, upon receipt of sensor data associated with the image of the user's hand 608, simulation engine 610 (e.g., the simulation engine 102 of FIG. 1) may be configured to compute a degree of opaqueness for item 606 from metadata (e.g., fabric type) associated with item 606. Simulation engine 610, based on the computed degree of opaqueness, may cause electronic device 604 to display hand image 612 on electronic device 604 as sensory output. Moreover, a portion of the item 606 may be displayed over the hand image 612 so that a portion of hand image 612 may still be seen, to some extent, beneath the item 606, thus, indicating a degree of opaqueness associated with item 606.

The user 602 may also utilize a camera on electronic device 604 to detect a lighting condition 616 of the user's current surroundings. For example, the user 602 may be outside on a sunny day and may wish to see what the item might look like outside, on a sunny day. Consider the case, where the user is viewing an item such as a shirt that has sequins attached. Upon receipt from the electronic device 604 of an image (e.g., a photo or video) indicating a lighting condition 616 (e.g., bright light, natural light, lighting source from behind the user), simulation engine 610, may determine a sensory output to present to user 602 depicting what the shirt would look like in lighting condition 616. This sensory output may be determined utilizing the lighting condition 616 and metadata associated with the item (e.g., sequins, color, opaqueness, etc.).

The user 602 may also utilize a camera on electronic device 604 to track movement of the electronic device and/or movement of the user. For example, the camera, or some other suitable sensor, may track eye movement by the user in order to ascertain a point of interest with respect to an electronic representation of an item being presented on the electronic device 604. As an illustrative example, the user 602 may look at particular area of the electronic representation of an item. The camera may be able to track eye movement and transmit such data as sensor data to simulation engine 610. Such sensor data may be utilized by simulation engine 610 in order to identify previously captured kinesthetic information, e.g., an image depicting an enlarged representation of the item at the particular area. The previously captured image may then be provided to the electronic device 604 for presentation as sensory output. Alternatively, the tracked eye movement may be used by the simulation engine 610 to overlay a “spotlight” feature that will illuminate the particular area with respect to the surrounding areas.

In yet another embodiment, the simulation engine 610 may simulate a manipulation of the item (e.g., stretching and/or twisting of the item). For example, the user 602 may utilize a camera on electronic device 604 to capture a video of the user 602 closing his or her hand as if grasping the item (e.g., a curtain). The user 602 may then indicate, for example, a twisting or stretching motion with his or her hand by twisting his hand or moving his pulled hand in any suitable direction respectively. Upon receipt of the video, the simulation engine 610 may identify previously captured kinesthetic information, e.g., a previously captured still image and/or video, depicting a corresponding stretching and/or twisting motion of the item. The previously captured still image and/or video may be provided for presentation on one or more electronic devices (e.g., the electronic device 604) as sensory output.

The user 602 may also utilize a camera on electronic device 604 to capture an image of the user's face, for example. Consider a case in which the user 602 is interested in obtaining beauty items (e.g., lipstick, foundation, blush, eye shadow, moisturizer, etc.). It may be the case that the user would like to see how the item would appear if applied. In such a case, the user may indicate, using a finger, stylus, or other pointing apparatus, one or more points on the captured image of the user's face and/or may “apply” the item (e.g., lipstick) by using a finger, for example, to trace where the item is to be applied (e.g., the user's lips). Thus, using the resulting sensor data and the captured image, the simulation engine 610 may generate a sensory output to present to user 602 simulating how the item (e.g., lipstick) would appear if applied to the user. For example, utilizing image recognition techniques, metadata associated with the item (e.g., viscosity and shade of lipstick), and sensor data, the simulation engine may generate an image of the user with the items applied. For example, simulation engine 610 may cause the item (e.g., the lipstick) to appear overlaid on the captured image (e.g., the user's face) in the area indicated by the user. This generated image could occur in real-time as the user is tracing the application of the lipstick, for example, or later, after the user has completed the trace. Though lipstick is used as an illustrative example, application of any substance applied to skin may be simulated.

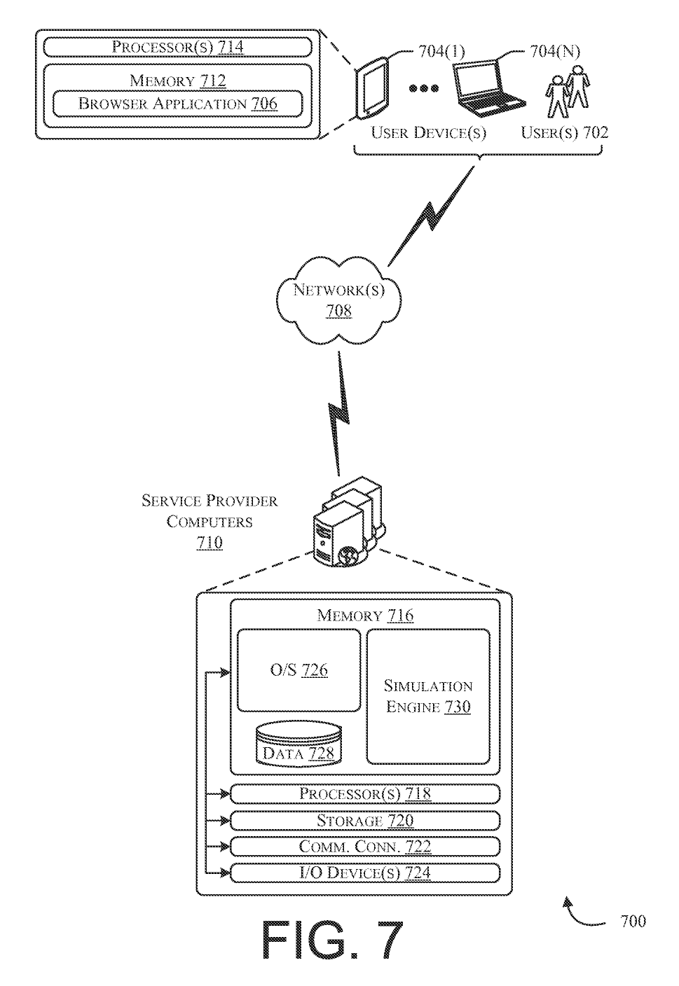

FIG. 7 depicts an illustrative system or architecture 700 for enabling a user to utilize a simulation engine (e.g., the simulation engine 102 of FIG. 1) while browsing items in an electronic marketplace (e.g., the electronic marketplace 106 of FIG. 1). In architecture 700, one or more users 702 (e.g., electronic marketplace consumers or users) may utilize user computing devices 704(1)-(N) (collectively, user computing devices 704) to access a browser application 706 (e.g., a web browser) or a user interface accessible through the browser application 706 via one or more networks 708. The user computing devices may include the same or similar user devices discussed in FIG. 1. In some aspects, content presented on the user computing devices 704 by browser application 706 may be hosted, managed, and/or provided by service provider computer(s) 710. Service provider computers 710 may, in some examples, provide computing resources such as, but not limited to, client entities, low latency data storage, durable data storage, data access, management, virtualization, hosted computing environment (e.g., “cloud-based)”software solutions, electronic content performance management, etc.

In some examples, the network 708, may be the same or similar to the network 108, and may include any one or a combination of many different types of networks, such as cable networks, the Internet, wireless networks, cellular networks and other private and/or public networks. While the illustrated example represents the users 702 accessing the browser application 706 (e.g., browser applications such as SAFARI®, FIREFOX®, etc., or native applications) over the network 708, the described techniques may equally apply in instances where the users 702 interact with service provider computers 710 via the one or more user computing devices 704 over a landline phone, via a kiosk, or in any other manner. It is also noted that the described techniques may apply in other client/server arrangements (e.g., set-top boxes, etc.), as well as in non-client/server arrangements (e.g., locally stored applications,

As discussed above, the user computing devices 704 may be any suitable type of computing device such as, but not limited to, a mobile phone, a smart phone, a personal digital assistant (PDA), a laptop computer, a desktop computer, a thin-client device, a tablet PC, an electronic book (e-book) reader, a wearable computing device, etc. In some examples, the user computing devices 704 may be in communication with the service provider computers 710 via the network 708, or via other network connections. Additionally, the user computing devices 704 may be part of the distributed system managed by, controlled by, or otherwise part of service provider computers 710.

In one illustrative configuration, the user computing devices 704 may include at least one memory 712 and one or more processing units (or processor device(s)) 714. The memory 712 may store program instructions that are loadable and executable on the processor device(s) 714, as well as data generated during the execution of these programs. Depending on the configuration and type of user computing devices 704, the memory 712 may be volatile (such as random access memory (RAM)) and/or non-volatile (such as read-only memory (ROM), flash memory, etc.). The user computing devices 704 may also include additional removable storage and/or non-removable storage including, but not limited to, magnetic storage, optical disks, and/or tape storage. The user computing devices 704 may include multiple sensors, including, but not limited to, an accelerometer, a microphone, an image capture (e.g., digital camera/video recording) device, or any suitable sensor configured to receive kinesthetic information from a user of the device. The disk drives and their associated non-transitory computer-readable media may provide non-volatile storage of computer-readable instructions, data structures, program modules, and other data for the computing devices. In some implementations, the memory 712 may include multiple different types of memory, such as static random access memory (SRAM), dynamic random access memory (DRAM), or ROM.

Turning to the contents of the memory 712 in more detail, the memory 712 may include an operating system and one or more application programs, modules, or services for implementing the features disclosed herein including at least the perceived latency, such as via the browser application 706 or dedicated applications (e.g., smart phone applications, tablet applications, etc.). The browser application 706 may be configured to receive, store, and/or display a network pages generated by a network site (e.g., the electronic marketplace 106), or other user interfaces for interacting with the service provider computers 710. Additionally, the memory 712 may store access credentials and/or other user information such as, but not limited to, user IDs, passwords, and/or other user information. In some examples, the user information may include information for authenticating an account access request such as, but not limited to, a device ID, a cookie, an IP address, a location, or the like.

In some aspects, the service provider computers 710 may also be any suitable type of computing devices and may include any suitable number of server computing devices, desktop computing devices, mainframe computers, and the like. Moreover, the service provider computers 710 could include a mobile phone, a smart phone, a personal digital assistant (PDA), a laptop computer, a thin-client device, a tablet PC, etc. Additionally, it should be noted that in some embodiments, the service provider computers 710 are executed by one more virtual machines implemented in a hosted computing environment. The hosted computing environment may include one or more rapidly provisioned and released computing resources, which computing resources may include computing, networking and/or storage devices. A hosted computing environment may also be referred to as a “cloud” computing environment. In some examples, the service provider computers 710 may be in communication with the user computing devices 704 and/or other service providers via the network 708, or via other network connections. The service provider computers 710 may include one or more servers, perhaps arranged in a cluster, as a server farm, or as individual servers not associated with one another. These servers may be configured to implement the content performance management described herein as part of an integrated, distributed computing environment.

In one illustrative configuration, the service provider computers 710 may include at least one memory 716 and one or more processing units (or processor device(s)) 718. The memory 716 may store program instructions that are loadable and executable on the processor device(s) 718, as well as data generated during the execution of these programs. Depending on the configuration and type of service provider computers 710, the memory 716 may be volatile (such as RAM) and/or non-volatile (such as ROM, flash memory, etc.). The service provider computers 710 or servers may also include additional storage 720, which may include removable storage and/or non-removable storage. The additional storage 720 may include, but is not limited to, magnetic storage, optical disks and/or tape storage. The disk drives and their associated computer-readable media may provide non-volatile storage of computer-readable instructions, data structures, program modules and other data for the computing devices. In some implementations, the memory 716 may include multiple different types of memory, such as SRAM, DRAM, or ROM.

The memory 716, the additional storage 720, both removable and non-removable, are all examples of non-transitory computer-readable storage media. For example, non-transitory computer-readable storage media may include volatile or non-volatile, removable or non-removable media implemented in any suitable method or technology for storage of information such as computer-readable instructions, data structures, program modules, or other data. The memory 716 and the additional storage 720 are all examples of non-transitory computer storage media. Additional types of computer storage media that may be present in the service provider computers 710 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the service provider computers 710. Combinations of any of the above should also be included within the scope of computer-readable media.

The service provider computers 710 may also contain communications connection interface(s) 722 that allow the service provider computers 710 to communicate with a stored database, another computing device or server, user terminals and/or other devices on the network 708. The service provider computers 710 may also include I/O device(s) 724, such as a keyboard, a mouse, a pen, a voice input device, a touch input device, a display, speakers, a printer, etc.

Turning to the contents of the memory 716 in more detail, the memory 716 may include an operating system 726, one or more data stores 728, and/or one or more application programs, modules, or services for implementing the features disclosed herein including a simulation engine 730.

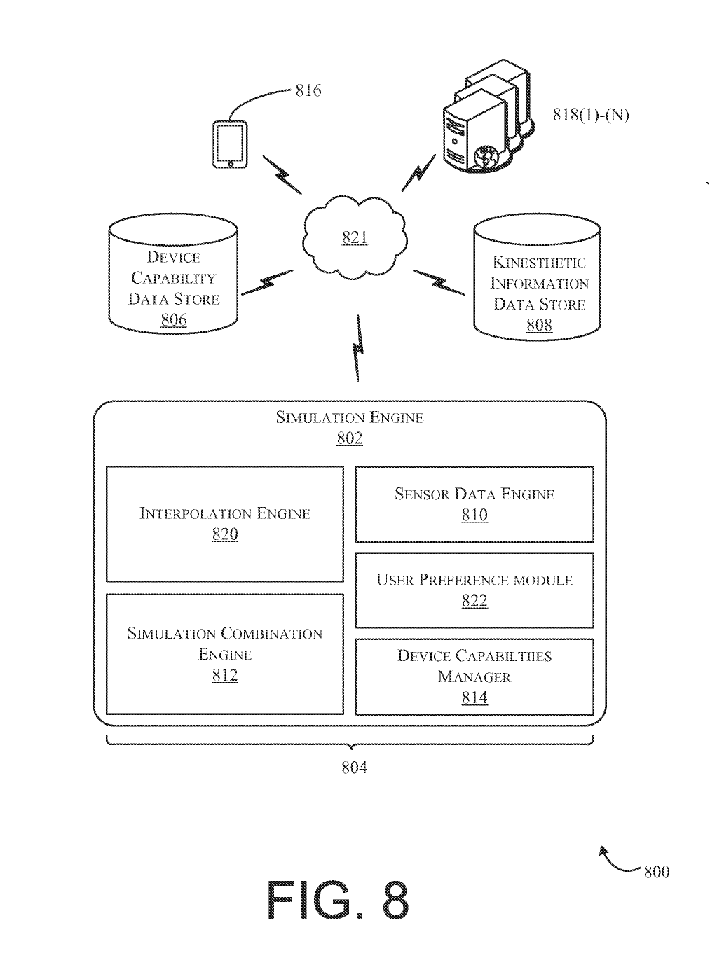

FIG. 8 schematically illustrates an example computer architecture 800 for the simulation engine 802 (e.g., the simulation engine 102 of FIG. 1) including a plurality of modules 804 that may carry out various embodiments. The modules 804 may be implemented in hardware or as software implemented by hardware. If the modules 804 are software modules, the modules 804 can be embodied on a computer readable medium and processed with a processor in any of the computer systems described herein. It should be noted that any module or data store described herein, may be, in some embodiments, a service responsible for managing data of the type required to make corresponding calculations. The modules 804 may be configured in the manner suggested in FIG. 8 or may exist as separate modules or services external to the simulation engine 802. In at least one example, simulation engine 802 resides on electronic device 816. Alternatively, simulation engine 802 may reside on service provider computers 818 or some other location separate from the electronic device 816.

In the embodiment shown in the drawings, a device capability data store 806, and a kinesthetic information data store 808 are shown, although data can be maintained, derived, or otherwise accessed from various data stores, either remotely or locally, to achieve the functions described herein. The simulation engine 802, shown in FIG. 8, includes various modules such as a sensor data engine 810, a simulation combination engine 812, a device capabilities manager 814, an interpolation engine 820, and a user preference module 822. Some functions of the modules 810, 812, 814, 820, and 822 are described below. However, for the benefit of the reader, a brief, non-limiting description of each of the engines/modules is provided in the following paragraphs.

In accordance with at least one embodiment, a process is enabled for providing seller recommendations as well as a method for tracking and reporting human interactions with seller recommendations. For example, a user (e.g., a customer and/or user of an electronic marketplace) may utilize electronic device 816 (e.g., the electronic device 104 of FIG. 1) to receive browse to an item offered on an electronic marketplace provided by service provider computers 818 (e.g., service provider computers 710). Service provider computers 818 may be configured to communicate with network 821. It should be appreciated that network 821 may be the same or similar as the network 108 described in connection with FIG. 1. Upon browsing to the item, the user may select an option to virtually interact with the item. In at least one example, the user may be prompted for input.

In accordance with at least one embodiment, sensor data engine 810, a component of simulation engine 802, may be configured to receive sensor data from electronic device 816. Such sensor data may include, but is not limited to video/still images, microphone input, indications of touch, as described above. Upon receipt of such sensor data, sensor data engine 810 may be configured to initiate one or more workflows with one or more other components of simulation engine 102. Sensor data engine 810 may further be configured to interact with kinesthetic information data store 808.

In accordance with at least one embodiment, simulation combination engine 812, a component of simulation engine 802, may be configured to combine two or more records from kinesthetic information data store 808. Simulation combination engine 812 may receive stimulus from sensor data engine 810 indicating that two or more records from kinesthetic information data store 808 should be combined. Simulation combination engine 812 may further be configured to interact with device capabilities manager 814 and/or device capability data store 806.

In accordance with at least one embodiment, device capabilities manager 814, a component of simulation engine 802, may be configured to receive and store device capability information associated with electronic device 816. Such capability information may include, but is not limited to, a processor speed, a graphics card capability, an available amount of memory, etc. Upon receipt of capability, device capabilities manager 814 may be configured interact with device capability data store 806. Device capabilities manager 814 may be configured to communicate with electronic device 816 for ascertaining capabilities of electronic device 816. Device capabilities manager 814 may further be configured to interact any other component of simulation engine 802.

In accordance with at least one embodiment, interpolation engine 820, a component of simulation engine 802, may be configured to interpolate one or more visual representations, and/or one or more audio representations of an item on an electronic marketplace. Interpolation engine 820 may further be configured to interact any other component of simulation engine 802, device capability data store 806, and/or kinesthetic information data store 808.

In accordance with at least one embodiment, user preference module 822, a component of simulation engine 802, may be configured to receive user preference information from electronic device 816 and/or service provider computers 818. User preference module 822 may be configured to store such information. User preference module 822 may further be configured to interact with any other module/engine of simulation engine 802.

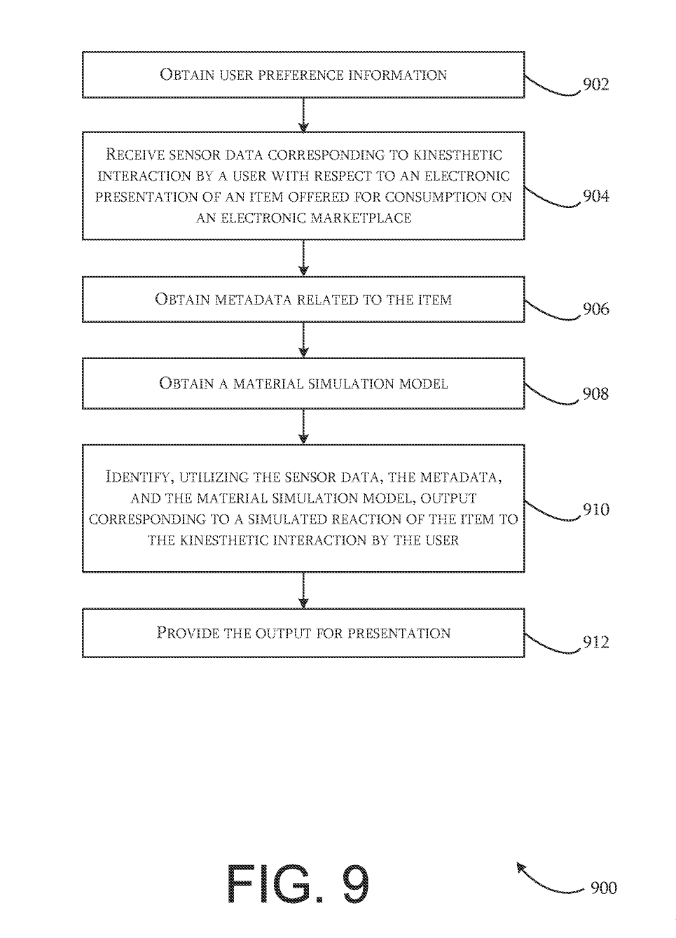

FIG. 9 is a flowchart illustrating a method 900 for generating a sensory output simulating a physical interaction by a user with a physical item based on a kinesthetic interaction by the user with an electronic representation of the item. In the illustrated embodiment, the method is implemented by a simulation engine, such as the simulation engine 802. Beginning at block 902, user preference information may be received by a user preference module 822 of the simulation engine 802. User preference information may include, but is not limited to, a power management preference, a sensory feedback preference, an indication of real-time playback/delayed playback preference, and/or subtitle preference. In an illustrative example, a user may prefer to input sensor data and wait a threshold amount of time before seeing the corresponding sensory output. The user may select such a preference in, for example, a network page provided to record such preferences. Sensor data engine 810 may be configured to utilize such user preference information when providing sensory output for presentation.

Sensor data produced as a result of the kinesthetic interaction by a user with the electronic representation of the item is received at block 904. As noted above, the user may search for various items offered in an electronic marketplace 106 by utilizing a search query, bar code scanning application, or some other suitable search technique, in order to select an item to view. Upon selection of an option to kinesthetically interact with the item, the user may kinesthetically interact with the electronic representation of item using the electronic device, resulting in the sensors of the electronic device generating sensor data as described above. Such sensor data may be received by sensor data engine 810 of FIG. 8. Sensor data may include, but is not limited to, any sensor data discussed above with respect to FIGS. 3-6.

At block 906, the simulation engine 802 may ascertain metadata related to the item. Such metadata may include item information such as weight, dimensions, product description, material type, viscosity, and the like. Alternatively, the simulation engine 802 may ascertain such metadata from service provider computers 818 of FIG. 8, or from any suitable storage location configured to store such information.

At block 908, the simulation engine 802 may obtain a material simulation model. Such a model may include a mapping of one or more sensor readings to one or more kinesthetic interactions stored in a suitable location, for instance, kinesthetic information data store 808 of FIG. 8. Alternatively, the material simulation model may provide an approximate simulation of certain physical systems, such as rigid body dynamics, soft body dynamics, fluid dynamics, and material dynamics. For example, the material simulation model, given metadata associated with an item (e.g., a men's dress shirt), may simulate a movement or sound of an electronic representation of the item in response to received sensor data.

At block 910, the simulation engine 802 may identify, utilizing the received sensor data, the metadata associated with the item, and the material simulation model, a sensory output simulating a physical interaction with the item based on a kinesthetic interaction with an electronic representation of the item. The sensory output identified at block 908 may then be provided to the electronic device at block 912 for presentation. For example, the material simulation model may indicate that, given a particular tilt motion of the electronic device, a particular video should be provided for presentation on the electronic device as sensory output. In another example, a user may wave the electronic device back and forth over some amount of time while viewing an electronic representation of the item. Thus, an accelerometer of the electronic device may generate sensor data that indicates the waving motion described. The simulation engine 802 may use such sensor data to lookup previously captured kinesthetic information associated with the item. Consider the case where the item is a men's dress shirt. The user, while viewing an image of the shirt on the electronic device, may utilize the electronic device to simulate waving the shirt gently back and forth on a hanger. The various tilt angles and rate of tilt changes of the electronic device, while waving it back and forth, may be determined from sensor data received by the simulation engine 802 from an accelerometer present in the electronic device. The simulation engine 802 may consult a mapping of such sensor data to previously captured kinesthetic information, e.g., a previously recorded video depicting the men's dress shirt being gently waved back and forth on a hanger. Similarly, the user may “bounce” the electronic device and the sensor data generated by such a motion may be received by simulation engine 802 and, in a similar manner as described above, the simulation engine 802 may retrieve previously captured kinesthetic information, e.g., a video depicting the men's dress shirt being “bounced” on a hanger. The simulation engine 802 may then provide the previously captured kinesthetic information to the electronic device for presentation as sensory output. As a further illustrative example, consider the case where the item is liquid foundational makeup. The user may utilize the electronic device to simulate smearing the liquid by waving the electronic device back and forth, for example, while viewing an image of the user's face. In such a case, the simulation engine 802 may use sensor data produced by the electronic device's accelerometer to lookup previously captured kinesthetic information, e.g., an image or video of the liquid foundation being applied, and provide the previously captured kinesthetic information to the electronic device for presentation as sensory output. In at least one example, the previously captured video may depict the liquid moving as if it were being applied on a piece of material (e.g., a piece of blotting paper).

In some situations, the simulation engine 802 may be unable to identify previously captured kinesthetic information for the sensor data received. In such cases, the simulation engine 802 may utilize another component of simulation engine 802 (e.g., interpolation engine 820) to interpolate an image, a video, a haptic feedback, a gustatory sensory output, a olfactory feedback, and/or an audio recording corresponding to the received sensor data utilizing the sensor data, metadata associated with the item, and a material simulation model. In some cases, information stored in the kinesthetic information data store 808 may be used. For example, consider the case where the item has been previously videotaped gently waving on a hanger. The sensor data received from the device may specify a more violent motion indicated by larger tilt angles, at faster speeds, than those associated with the previously captured video. In such a case, interpolation engine 820, utilizing the material simulation model may generate a video simulating the item being subjected to an exaggerated movement, at a faster speed, with respect to the previously captured video.

In some instances, the simulation engine 802 may generate sensory output including haptic feedback utilizing the sensor data, metadata associated with the item, and/or a material simulation model. “Haptic feedback” is intended to refer to output that is associated with the sense of touch. If the device capabilities manager 814 determines that the electronic device is capable of providing haptic feedback as a sensory output, the simulation engine 802 may cause tactile sensors/hardware on the device to present the haptic feedback as sensory output simulating the physical feel of the item. In at least one embodiment, the haptic feedback is provided by the screen of the electronic device changing texture.

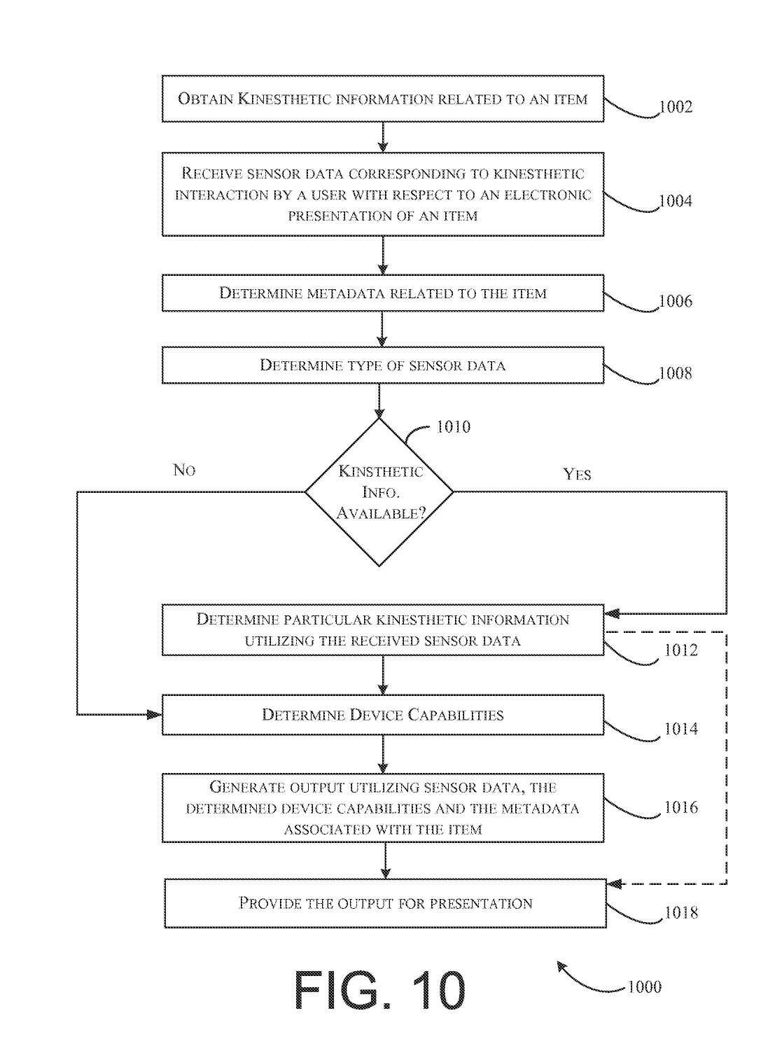

FIG. 10 is a flowchart illustrating another example method 1000 for generating a simulated interaction between a user and an item based on kinesthetic information utilizing a simulation engine, such as the simulation engine 802 of FIG. 8. The flow may begin at block 1002, where kinesthetic information related to an item may be received. The item may be offered in an electronic marketplace. The kinesthetic information may by one or more digital images, video recording, and/or audio recordings, as discussed above. In at least one example, the kinesthetic information may have been recorded and/or defined as part of a workflow associated with listing the item on the electronic marketplace.

In accordance with at least one embodiment, sensor data corresponding to a kinesthetic interaction by a user with respect to an electronic presentation of an item may be received at block 1004. Such sensor data may be any of the example sensor data discussed in the above figure descriptions. At block 1006, metadata related to the item may be determined in a similar manner as described in connection with FIG. 9. At block 1008, a type of sensor data may be determined. Such sensor data types may identify the sensor data as a video or audio type. For example, sensor data engine 810 may determine that the received sensor data corresponds to audio sensor data received via a microphone located on the electronic device. Given such a determination, the simulation engine 802 may determine that the sensor data is an audio type.

At decision block 1010, a determination may be made as to whether corresponding kinesthetic information is available for the determined sensor data type. For example, multiple types of kinesthetic information may be stored (e.g., in kinesthetic information data store 808 of FIG. 8) related to the item. For instance, an item may have one or more video recordings, and/or one or more still images, depicting various movements of the item, and/or one or more audio recordings associated with a physical interaction with the item (e.g., rubbing the item between one's fingers, tapping the item, etc.).

If kinesthetic information exists that corresponds to the type of sensor data determined at block 1008, the flow may proceed to block 1012, where particular kinesthetic information may be determined utilizing the received sensor data. For example, if the sensor data is determined to be audio data generated by a microphone on the electronic device, and there exists previously captured audio recordings of the item, then sensor data engine 810 may attempt to determine a particular audio recording based on the received audio sensor data. In some examples, the particular audio recording may not sufficiently correspond to the audio sensor data received. For example, if the user “taps” on a particular area of a vase, but the audio recording stored corresponds to a different area of the vase, the flow may proceed to block 1014. Alternatively, if the particular audio recording does correspond to the audio sensor data received, then the particular audio recording may be provided for presentation on the electronic device at block 1018.

If kinesthetic information that corresponds to the type of sensor data determined at block 1008 does not exist, the flow may proceed to block 1014. Alternatively, if the particular audio recording does not sufficiently correspond to the audio sensor data received, the flow may proceed to block 1014. Device capabilities of the electronic device may be determined at block 1014. In at least one example, device information may be received by the simulation engine 802 and/or the simulation engine 802 may ascertain such device information from any suitable storage location configured to store such information (e.g., device capability data store 806 of FIG. 8). Depending on the device capabilities (e.g., whether the device has sufficient capabilities to present the simulated video/audio representation), the simulation engine 802 may convert a video/audio recording to a different format (e.g., a format of which the electronic device is capable of presenting).

Where kinesthetic information was not available or the kinesthetic information available did not sufficiently correspond with the received sensor data, sensory output may be generated by the simulation engine 802 utilizing the received sensor data, the determined device capabilities and the metadata associated with the item at block 1016. In one example, such generation includes an interpolated sensory output determined from information related to one or more captured kinesthetic information. Alternatively, such information may be utilized with a material simulation model to generate a sensory output to present on the electronic device simulating a physical interaction with the item.

In accordance with at least one embodiment, it may be necessary to combine previously captured kinesthetic information associated with an item. For example, a video recording depicting the item being waved back and forth on a hanger and a video recording depicting the item being “bounced” on a hanger may each partially correspond to sensor data received from sensor on the electronic device. In such examples, a simulation combination engine 812 of the simulation engine 802 may be utilized to combine the two videos for generating a new video that depicts the item waving back and forth, while simultaneously “bouncing” on the hanger.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of any embodiment.

Various embodiments of this disclosure are described herein, including the best mode known to the inventors for carrying out the embodiments. Variations of embodiments may become apparent to those of ordinary skill in the art upon reading the foregoing description. The inventors expect skilled artisans to employ such variations as appropriate and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by this disclosure unless otherwise indicated herein or otherwise clearly contradicted by context.

In the description above, various embodiments of the present disclosure have been described. For purposes of explanation, specific configurations and details have been set forth in order to provide a thorough understanding of the embodiments. However, it will also be apparent to one skilled in the art that the embodiments may be practiced without the specific details. Furthermore, well-known features may be omitted or simplified in order not to obscure the embodiment being described above.

Some or all of the process described may be performed under the control of one or more computer systems configured with specific computer-executable instructions and may be implemented as code (e.g., executable instructions, one or more computer programs or one or more applications) executing collectively on one or more processors, by hardware or combinations thereof. The code may be stored on a non-transitory computer-readable storage medium, for example, in the form of a computer program or module including a plurality of instructions executable by one or more processors. The computer-readable storage medium may be non-transitory.

All references, including publications, patent applications and patents, cited herein are hereby incorporated by reference to the same extent as if each reference were individually and specifically indicated to be incorporated by reference and were set forth in its entirety herein.

What is claimed is:

1. A computer-implemented method comprising:
receiving, from an electronic device, accelerometer data corresponding to kinesthetic interaction by a user with respect to an electronic presentation of an item of clothing offered in an electronic marketplace;
obtaining metadata related to the item, the metadata including at least a fabric type associated with the item;
identifying a material simulation model utilizing the metadata related to the item;
determining, utilizing the accelerometer data, the metadata, and the material simulation model, one or more images to present on the electronic device, the one or more images depicting a simulation of a physical interaction by the user with the item; and
providing the one or more images for presentation on the electronic device.

2. The computer-implemented method of claim 1, wherein the material simulation model comprises a mapping of the accelerometer data to at least one previously captured image of the item.

3. The computer-implemented method of claim 2, wherein the determining of one or more images to present on the electronic device further comprises:
generating at least one interpolated image utilizing the accelerometer data, the at least one previously captured image of the item, and the material simulation model.

4. A system, comprising:
a memory configured to store at least specific computer-executable instructions; and
a processor in communication with the memory and configured to execute the specific computer-executable instructions to at least:
receive sensor data corresponding to a kinesthetic interaction by a user with respect to an electronic presentation of an item on an electronic device;
identify a material simulation model associated with the item;
obtain metadata related to the item;
identify, utilizing the sensor data, the metadata, and the material simulation model, a sensory output simulating a physical interaction by the user with respect to the item; and
causing the sensory output to be presented to the user on the electronic device.

5. The system of claim 4, wherein the sensory output is interpolated from previously captured kinesthetic information associated with the item.

6. The system of claim 5, wherein the metadata associated with the item indicates a type of fabric.

7. The system of claim 5, wherein the processor is further configured to execute the specific computer-executable instructions to at least determine a capability of the electronic device to present the sensory output, the capability of the electronic device including at least one of a processor speed or an available memory.

8. The system of claim 5, wherein the material simulation model comprises a graphics simulation model.

9. The system of claim 5, wherein the material simulation model provides a mapping of the sensor data to previously captured images of the item, and wherein sensory output comprises the one or more previously captured images of the item.

10. The system of claim 5, wherein the sensory output comprises a combination of at least one of a visual element, a tactile element, a gustatory element, an olfactory element, or an auditory element.

11. The system of claim 5, wherein sensory output comprises a visual element depicting a degree of opaqueness of the item.

12. The system of claim 5, wherein the sensory output comprises an auditory element providing a sound associated with the item.

13. The system of claim 5, wherein the sensory output comprises a tactile element providing haptic feedback associated with the item.

14. The system of claim 5, wherein the sensor data comprises data received from at least one of an accelerometer, a microphone, a tactile sensor, a gustatory sensor, an olfactory sensor, or an image capturing device.

15. The system of claim 5, wherein the sensor data comprises data received from a microphone that indicates a force at which air passes the microphone.

16. A non-transitory computer-readable storage medium having stored thereon computer-executable instructions that, when executed by a computer, cause the computer to perform operations comprising:
receiving, from an electronic device, sensor data corresponding to a kinesthetic interaction with respect to an electronic representation of an item on an electronic device;
identifying a material simulation model associated with an item, the material simulation model simulating a physical aspect of the item;
interpolating, utilizing the sensor data, metadata related to the item, and the material simulation model, a sensory output simulating a physical interaction with the item; and
providing the sensory output for presentation on the electronic device.

17. The non-transitory computer-readable medium of claim 16, wherein the sensory output comprises first image overlaid with a second image of the item.

18. The non-transitory computer-readable medium of claim 17, wherein the item includes a material applied to skin and the first image comprises an image of a portion of the user.

19. The non-transitory computer-readable medium of claim 16, wherein the sensor data includes an indication of a lighting condition.

20. The non-transitory computer-readable medium of claim 19, wherein sensory output reflects the lighting condition.
